(19) United States
(12) Patent Application Publication
(10) Pub. No.: US 2018/0035635 A1
(43) Pub. Date: Feb. 8, 2018

(54) RAIL SYSTEM FOR MODULAR REPTILE AND SMALL ANIMAL CAGES

(71) Applicant: Benjamin C. Hutchinson, Altoona, PA (US)

(72) Inventor: Benjamin C. Hutchinson, Altoona, PA (US)

(21) Appl. No.: 15/670,815

(22) Filed: Aug. 7, 2017

Related U.S. Application Data
(60) Provisional application No. 62/371,479, filed on Aug. 5, 2016.

(51) Int. Cl. A01K 1/03

(52) U.S. Cl. CPC A01K 1/031

(57) ABSTRACT

A rail system for a modular reptile and small animal cage comprises a plurality of squared elongate channels, each channel having an X-shaped cross-section that includes: four arrowhead tips pointing to the corners of a square with a gap between adjacent arrowhead tips defining a slot for holding a cage side panel or a cage accessory. When combined with a plurality of side panels, bottom and top panel, these slotted elongate channels can be used to make an expandable, modular reptile/small animal cage. A method for making such cages is also disclosed.

### CROSS-REFERENCE TO RELATED APPLICATION

This is a perfection of U.S. Provisional Application Ser. No. 62/371,479, filed on Aug. 5, 2016, the disclosure of which is fully incorporated by reference herein.

### BACKGROUND OF THE INVENTION

This is a new design for the internal rails of a reptile or small animal cage. The rails, also called strut bars, channels and/or T-slots enable easy modular expansion of a cage in ALL directions, upward, front-to-back and from either side. These rails are meant to have one or more fixtures easily attached to them. Such fixtures include, but are not limited to, interior cage lights, heat panels, hide boxes, nesting boxes, hanging perches, hanging hammocks and basking spots among others. The rail system can be assembled and installed into an existing cage as somewhat of an interior sub-cage skeleton. Or, it can be made into one or more integrated cage panels. Or, it can be assembled to function as the whole cage unit by itself.

A known product currently sold online by Big Apple Pet Supply is not so easily expandable in an up-and-down direction due to the manner in which its individual stackable cage units connect to one another.

### SUMMARY OF THE INVENTION

The various components of this cage are believed to be new, nonobvious and proprietary. They include (a) the rail system, especially on top, for attachments; (b) how varying cage components slide together; (c) the way the vents screw into the cage panels for interchangeability; (d) the track lighting that can be added thereto; (e) the optional reservoir for substrate or water, and (f) its overall expansion capabilities.

One preferred embodiment of rail system includes a squared elongate channel that is substantially “X” shaped in cross-section. It is formed by a set of 4 arrowheads with their respective tips pointing to each of the corners of a square. Preferably, these arrowheads all emanate from a squared central axis through which one or more rods and/or wires may be fed. (Alternately, the squared central axis can be made circular, or rounded). Between any 2 adjoining arrow tips to this X-shaped rail, there is defined a track or slot into which a side panel alone, or panel with one or more connecting edge bolts, may be slid for holding it in place. These same tracks/slots may be used to hold one or more cage accessories described below.

A plurality of the aforementioned X bars can be joined together to form a rectangular box (per FIG. 1) with X's along each corner and with panels (side, top OR bottom) being slid into adjoining tracks/slots, 90 degrees apart, so as to form the framework for a cage. A base/bottom panel is added to the aforementioned cage box (rectangular) for leaving an opened top animal containment. Or, a top panel may be added as well to form a full, six panel variation. Note, however, that with the use of these X bars, connection to additional cubes leads to easy expansion of a pet cage in most every direction, top, bottom or side-to-side.

The aforementioned X bars are also readily adapted for adding one or more pet cage accessories into the cage interior. Particularly, by sliding into one or more open tracks/slots, the pet owner may supply his/her reptile/small animal with an interior cage light, a heat panel, a hide box, a nesting box, a hanging perch, a hanging hammock and/or basking spot (not shown). Inside the side panels, slid between adjacent X bars, a given side panel may be custom fitted with a watering reservoir, a dirt/topsoil reservoir and/or a multi-directional screened vent cover.

An alternative track/slot configuration (FIGS. 6 through 9) uses open-ended channels, with five or more sides and with raised lips emanating from both uppermost sides to form an alternate interlock means. This multiple-angled alternative to the above X-shaped channel forms a cage component holder that somewhat resembles an arrowhead in cross-section. These variations may be used for holding in place several right-angled sidewalls and/or interior track accessories like those mentioned above. Preferably, the outer tips to these alternative, pentagonal “plus” channels also include a single notched groove at both ends for interlocking to an adjacent cage sidewall and/or bottom panel.

A method for making such expandable, modular cages is also disclosed herein.

The advantages of this cage over a glass cage/aquarium for reptile keeping include: being lighter in weight, less susceptible to breaking, variable ventilation, and expandable to accommodate a growing reptile. Plastic offers more heat retention, while allowing for the use of lower wattage bulbs and better heat gradients.

The lights on the inside of this new cage configuration will allow for humidity to stay in the cage. These lights can be added onto space-efficient tracks along the upper rails of each unit or selected units.

The reservoir offers up to 18″ of dirt for burrowing reptiles without having to haul a metric ton of dirt. That reservoir will also be useful for turtle keepers for using as a water retention area.

The rail system of this cage will be adaptable for most any application, including partitions, lights, dividers, and species specific applications such as humidifiers, waterfalls, and elevated nesting boxes.

Airflow within the cage unit will be adjustable because the screw in vents can be easily changed out for other vents.

The cage can be expanded up, backwards, and sideways so users don't have to buy a whole new cage as their animal grows.

The top to each unit can come off easily for those that would prefer top access while the hinged doors will be continuous with the cage to avoid cracking of the plastic.

The reservoir may be equipped with a drain, to make water changing easier. As currently sized, it can hold about 22.4 or up to about 23 gallons of water when completely filled.

### SUMMARY OF THE DRAWINGS

Further features, advantages and objectives of this invention will be made clearer with the following detailed description made with reference to the accompanying drawings in which:

FIG. 1 is an upper right corner perspective view of a cage structure made from two side panels and a top and bottom panel per one embodiment of this invention;

FIG. 2 is a side axial perspective view of the cage structure from FIG. 1;

FIG. 3 is a top perspective view a single cage unit per this invention, said cage unit consisting of a pair of “X” rails with a side panel slid into both top channels of the adjoining “X” rails;

FIG. 4 is a top plan close up view of the circled region from FIG. 3;

FIG. 5 is a close up, axial perspective view of an “X” rail with the trapezoidal protuberance of one side panel slid into one of four tracks to that elongated channel;

FIG. 6 is a top plan view of a top cage panel per a first alternative embodiment of this invention with its pair of pentagonal accepting grooves;

FIG. 7 is side sectional view taken along lines VII-VII of FIG. 6;

FIG. 8 is a close up view of the circled region VIII of FIG. 7; and

FIG. 9 is a close up view of the circled region IX of FIG. 7.

### DETAILED DESCRIPTION OF PREFERRED EMBODIMENTS

One preferred embodiment of a full cage per this invention will measure about 4′×2′×18″. The fact that its various components will easily slides together means it will have a small shipping profile, of about 4′×2′×3″ or less. Currently, the sides to that cage are ⅜″ acrylic, and the top and bottom are ½ inch thick polypropylene. Alternative materials may include some or all components being made from ABS, PVC, Polyethylene HDPE and LDPE, and fiberglass, for the top and bottom pieces. Applicant is considering acrylic and/or other clear plastic alternatives for his sides and expansion pieces as well as for the pentagon-shaped sliding corner rails. That would allow the latter components to be made with even thinner walls especially when compared to a dovetail or T-shapes “equivalent”. The doors should be on hinges that are actually an integral part of the front end assembly.

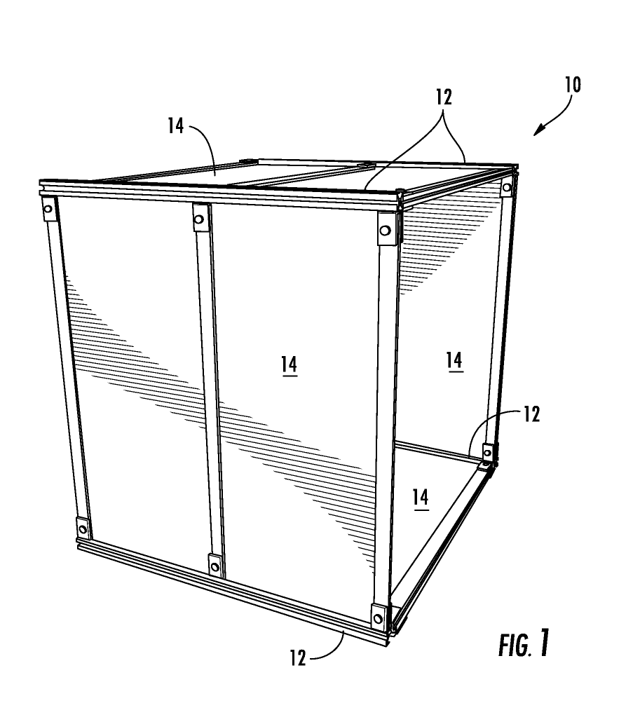

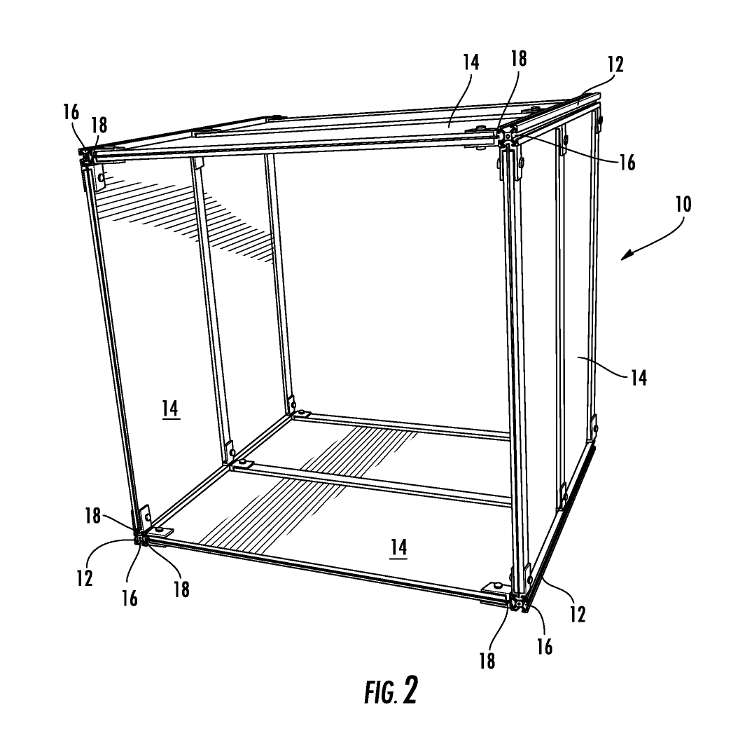

Referring now to FIGS. 1 through 5, there is shown a modular reptile and small animal cage skeleton, generally 10, made from multiple combinations of elongate channels 12 and cage side panels 14 joined to a slot 16 in the respective channels via protuberances 18 (or some other side panel extensions meant to slide within these slots 16 for joinder).

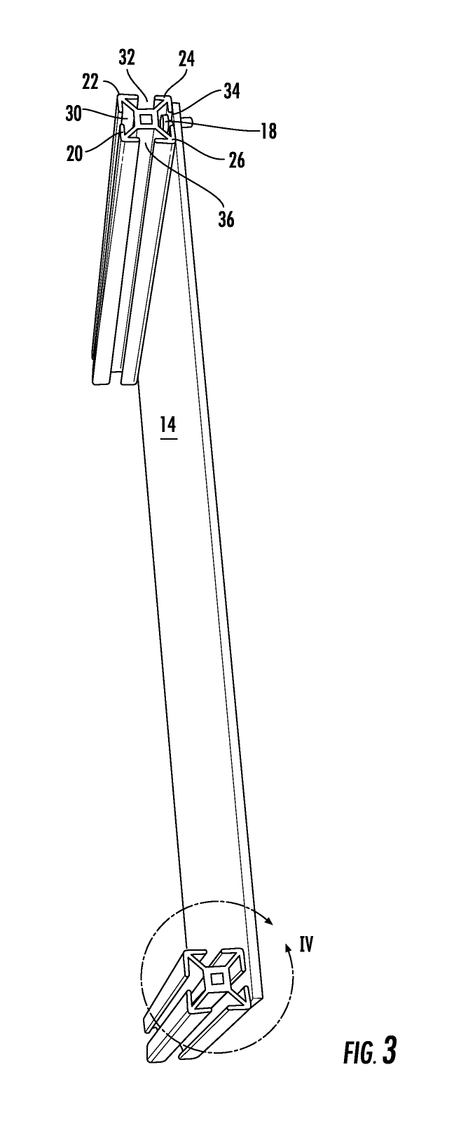

For any given elongate channel 12, there is an X-shape, cross-sectional in appearance, made by taking four arrowhead-shaped tips, 20, 22, 24 and 26 that extend outwardly from a square-shaped central axis 28. With the foregoing configuration of arrow tips and central axis, the preferred elongate channel of this invention creates 4 tracks or slots 30, 32, 34 and 36 that are essentially at the clock positions of noon, 3 o′clock, 6 o′clock and 9 o′clock as best seen at FIG. 4 of the accompanying drawings.

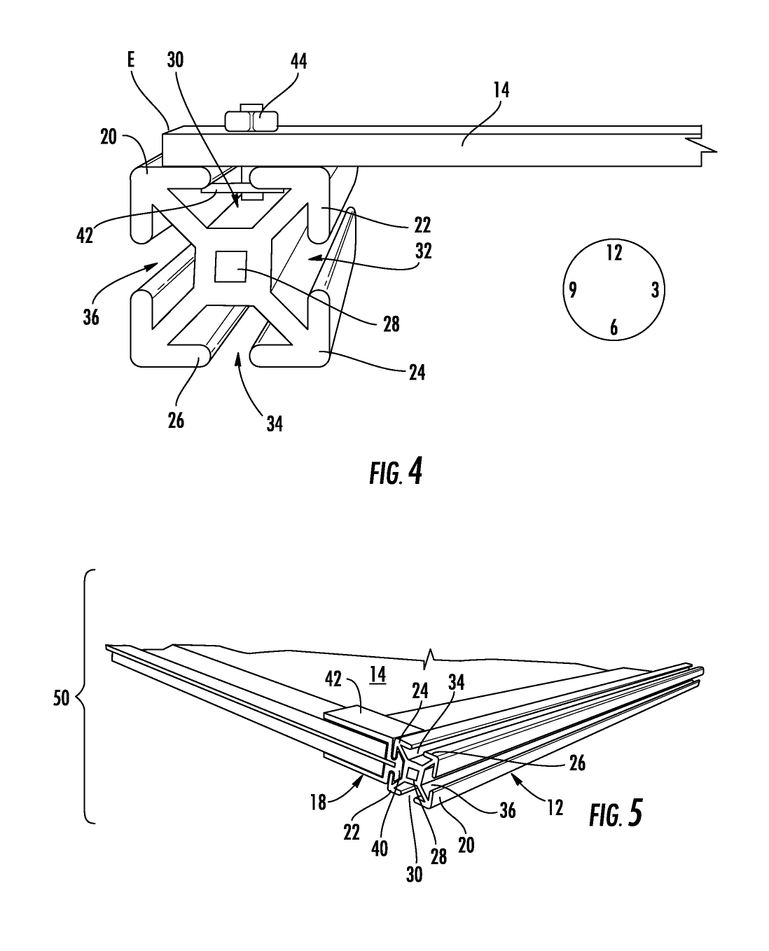

In FIG. 5, side panel protuberance 18 consists of a lipped trapezoidal part 40 that extends outwardly from a clip 42 secured to one edge E of its side panel 14. Alternate variations may include rounded central axes 48, assemblies, hooks and/or other slot slider configurations. The final combination is a cage wall component 50 with a full reptile and small animal cage comprising four such cage wall components at the respective corners affixed at their respective bottom edges to a cage bottom panel (not shown)—with a top panel also attached in a similar manner when a 6-sided rectangular box is preferred for its animal occupant over a non-lidded alternative.

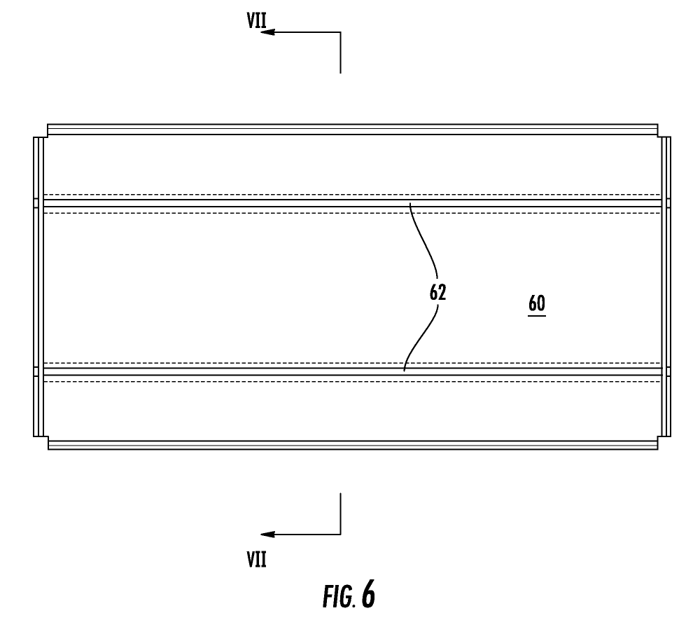

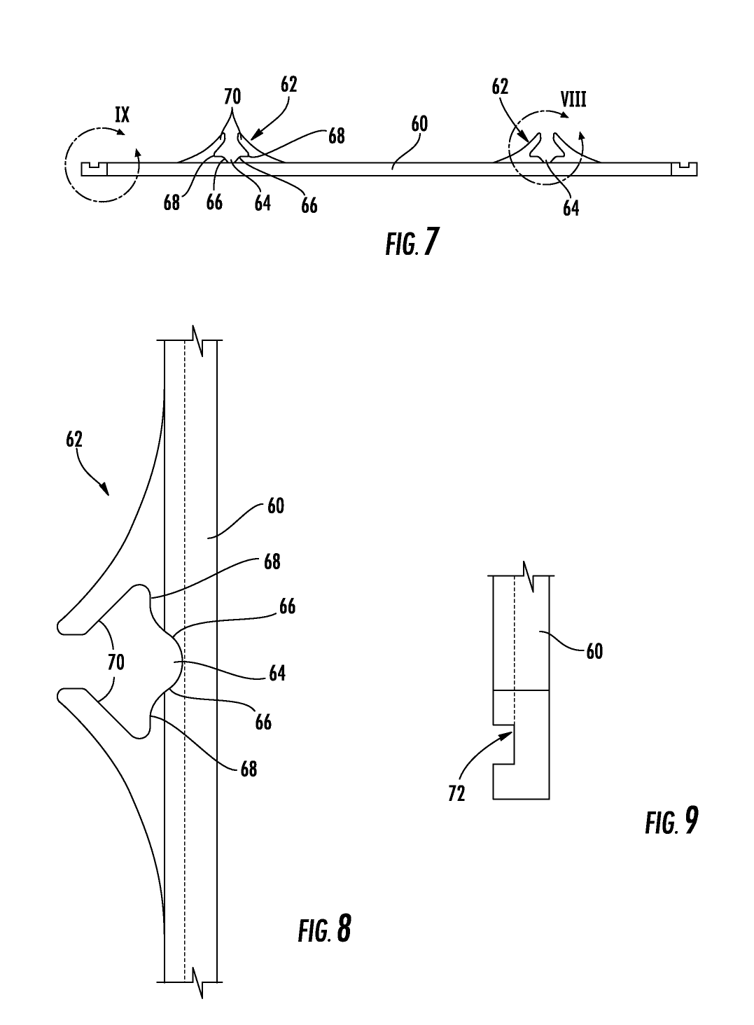

The second embodiment of rail structure per FIGS. 6 through 9 addresses a top panel or cage lid 60 having two separate tracks 62 therein. Each of the two tracks has a central groove 64 with a somewhat arrowhead cross-sectional look. That groove is actually pentagonal-angled, with a lowest most recess 66, a pair of lower sides 68 extending upwardly from recess 66 and then two raised lips 70 that form the means for securing another cage component within track 62. Note also how this alternate embodiment includes a single notched groove 72 for holding an adjoining panel's end (See, FIG. 9).

A method for making cages with these modular components comprises the steps of: providing a plurality of squared elongate channels, each channel having: (i) an X-shaped cross-section that includes: four arrowhead tips pointing to the corners of a square with a gap between adjacent arrowhead tips defining a slot for holding a cage side panel or a cage accessory; and (ii) a squared central axis that extends through the four arrowhead tips along the length of the elongate channel; providing a plurality of cage side panels, each side panel having along at least one edge a protuberance designed for sliding in the slot in the elongated channel; sliding a first cage side panel into the slot of a first elongated channel; sliding a second cage side panel into an adjacent slot of the first elongated channel at a right angle to the first cage side panel; joining additional cage side panels and elongated channels together to form a box-like cage structure; adding a cage bottom panel to the box-like cage structure; and adding a cage top panel to the box-like cage structure. Optionally, one may also add to an interior of that box-like cage structure by sliding into one or more slots of one or more elongated channels one or more accessories selected from the group consisting of: an interior cage light, a heat panel, a hide box, a nesting box, a hanging perch, a hanging hammock and a basking spot.

Having described the presently preferred embodiments, it is to be understood that the scope of this invention may be otherwise covered by the appended claims.

What is claimed is:

1. A rail system for a modular reptile and small animal cage, said rail system comprising:
a plurality of squared elongate channels, each channel having an X-shaped cross-section that includes: four arrowhead tips pointing to the corners of a square with a gap between adjacent arrowhead tips defining a slot for holding a cage side panel or a cage accessory.

2. The rail system of claim 1 wherein said elongate channels further include a squared central axis that extends through the four arrowhead tips along the length of the elongate channel, said central axis adapted for holding one or more connecting rods capable of joining adjacent cage side panels to form the modular reptile and small animal cage.

3. The rail system of claim 1 wherein at least two adjacent slots in the elongate channels hold cage side panels having protuberances along at least one edge for sliding in said slots and forming a right angled corner of the modular reptile and small animal cage thereby.

4. The rail system of claim 1 wherein said elongate channels are made from metal.

5. The rail system of claim 4 wherein said metal is selected from steel or aluminum.

6. The rail system of claim 1 wherein said elongate channels are made from plastic or a composite.

7. The rail system of claim 1 wherein the cage accessory is selected from the group consisting of: an interior cage light, a heat panel, a hide box, a nesting box, a hanging perch, a hanging hammock and a basking spot.

8. An expandable modular cage for a reptile or small animal, said cage comprising:
a plurality of elongated channels, each channel having at least one slot for holding a cage side panel or a cage accessory; and
a plurality of cage side panels, each side panel having along at least one edge a protuberance designed for sliding in the slot in the elongated channel and forming a cage wall component thereby.

9. The reptile or small animal cage of claim 8 wherein each elongated channel has an X-shaped cross-section that includes: four arrowhead tips pointing to the corners of a square with a gap between adjacent arrowhead tips defining the slot for holding the cage side panel or the cage accessory.

10. The reptile or small animal cage of claim 9 wherein each elongated channel further includes a squared central axis that extends through the four arrowhead tips along the length of the elongate channel, said central axis adapted for holding one or more connecting rods to join adjacent cage side panels.

11. The reptile or small animal cage of claim 9 wherein at least two adjacent slots in one of the elongated channels hold cage side panels to form a right angled cage corner.

12. The reptile or small animal cage of claim 9, which includes 4 cage wall components joined along their lower edges with a cage bottom panel.

13. The reptile or small animal cage of claim 12, which further includes a cage top panel.

14. The reptile or small animal cage of claim 12 wherein the cage bottom panel has an integral reservoir for holding water, food or dirt.

15. The reptile or small animal cage of claim 9, which may be expanded by joining additional elongated channels, cage side panels, and at least one of: a cage bottom panel and a cage top panel to an existing structure in an upper direction, a lower direction or from either cage side.

16. The reptile or small animal cage of claim 8 wherein each elongated channel has a slot resembling an arrowhead in cross-section with five or more angled sides and raised lips emanating from both uppermost sides.

17. The reptile or small animal cage of claim 16 wherein each elongated channel further includes a notched groove at opposed ends for joining adjacent cage side panels or to the cage bottom panel.

18. The reptile or small animal cage of claim 8 wherein the cage accessory is selected from the group consisting of: an interior cage light, a heat panel, a hide box, a nesting box, a hanging perch, a hanging hammock and a basking spot.

19. A method of making an expandable modular cage for a reptile or small animal, said method comprising:
(a) providing a plurality of squared elongate channels, each channel having: (i) an X-shaped cross-section that includes: four arrowhead tips pointing to the corners of a square with a gap between adjacent arrowhead tips defining a slot for holding a cage side panel or a cage accessory; and (ii) a squared central axis that extends through the four arrowhead tips along the length of the elongate channel;
(b) providing a plurality of cage side panels, each side panel having along at least one edge a protuberance designed for sliding in the slot in the elongated channel;
(c) sliding a first cage side panel into the slot of a first elongated channel;
(d) sliding a second cage side panel into an adjacent slot of the first elongated channel at a right angle to the first cage side panel;
(e) joining additional cage side panels and elongated channels together to form a box-like cage structure;
(f) adding a cage bottom panel to the box-like cage structure; and
(g) adding a cage top panel to the box-like cage structure.

20. The method of claim 19, which further includes:
adding to an interior of the box-like cage structure by sliding into one or more slots of one or more elongated channels one or more accessories selected from the group consisting of: an interior cage light, a heat panel, a hide box, a nesting box, a hanging perch, a hanging hammock and a basking spot.
